(19) United States
(12) Patent Application Publication
(10) Pub. No.: US 2026/0186338 A1
(43) Pub. Date: Jul. 2, 2026

(54) POLARIZATION MODULATOR AND DISPLAY APPARATUS

(71) Applicant: Coretronic Corporation, Hsin-Chu (TW)

(72) Inventors: Hsin Huang, Hsin-Chu (TW); Ping-Yen Chen, Hsin-Chu (TW); Chung-Yang Fang, Hsin-Chu (TW)

(73) Assignee: Coretronic Corporation, Hsin-Chu (TW)

(21) Appl. No.: 19/426,017

(22) Filed: Dec. 18, 2025

(30) Foreign Application Priority Data
Dec. 27, 2024 (CN) 202411954693.8

(51) Int. Cl. G02F 1/1335; G02F 1/13357; G02F 1/13363; G02F 1/1337

(52) U.S. Cl. CPC G02F 1/133528; G02F 1/1336; G02F 1/13363; G02F 1/1337

(57) ABSTRACT

A display apparatus including a display panel, a first electrically controlled phase retarder, a polarization modulator and a second polarizer is provided. The polarization modulator includes a first polarizer and a polarization modulation unit. The polarization modulation unit includes a first phase retardation film. An orthographic projection of a first optical axis of the first phase retardation film on the display surface is not parallel and not perpendicular to an orthographic projection of a first absorption axis of the first polarizer on the display surface. A sum of the in-plane phase retardation of the polarization modulation unit is greater than or equal to -50 nm and less than or equal to 50 nm. The first electrically controlled phase retarder is located between the second polarizer and the polarization modulator. A second absorption axis of the second polarizer is perpendicular to the first absorption axis.

### CROSS-REFERENCE TO RELATED APPLICATION

This application claims the priority benefit of China application serial no. 202411954693.8, filed on December 27, 2024. The entirety of the above-mentioned patent application is hereby incorporated by reference herein and made a part of this specification.

### BACKGROUND

### Technical Field

The disclosure relates to a display technology, and more particularly, to a display apparatus.

### Description of Related Art

To enhance driving safety, in-vehicle display apparatuses can be designed to have a single-sided anti-peeping effect. For example, while the vehicle is in motion, the single-sided anti-peeping function can be activated, preventing the display apparatus from showing images to the driver while allowing it to display images to the passenger. However, when driving at night, the displayed image on the non-anti-peeping side may be reflected by the passenger-side window or windshield to form a mirrored image, preventing the driver from clearly observing the real-time road conditions on the side of the vehicle through the passenger-side window, causing inconvenience and even endangering driving safety.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a polarization modulator and a display apparatus.

Other objectives and advantages of the disclosure may further be understood from technical features disclosed in the disclosure.

In order to achieve one or a portion of or all of the objects or other objects, an embodiment of the disclosure provides a display apparatus including a display panel, a first electrically controlled phase retarder, a polarization modulator and a second polarizer. The display panel has a display surface. The first electrically controlled phase retarder is arranged to overlap the display panel. The polarization modulator includes a first polarizer and a polarization modulation unit. The polarization modulation unit includes a first phase retardation film. The first polarizer has a first absorption axis. The first phase retardation film has a first optical axis. An orthographic projection of the first optical axis on the display surface is not parallel and not perpendicular to an orthographic projection of the first absorption axis on the display surface. A sum of the in-plane phase retardation of the polarization modulation unit is greater than or equal to -50 nm and less than or equal to 50 nm. The second polarizer is disposed on one side of the first electrically controlled phase retarder facing away from the polarization modulator and has a second absorption axis. The second absorption axis is perpendicular to the first absorption axis.

In order to achieve one or a portion of or all of the objects or other objects, an embodiment of the disclosure provides a polarization modulator including a first polarizer and a polarization modulation unit. The polarization modulation unit includes a first phase retardation film. The first polarizer has a first absorption axis. The first phase retardation film has a first optical axis. An orthographic projection of the first optical axis on the first polarizer is not parallel and not perpendicular to the first absorption axis. A sum of the in-plane phase retardation of the polarization modulation unit is greater than or equal to -50 nm and less than or equal to 50 nm.

Other objectives, features and advantages of the disclosure will be further understood from the further technological features disclosed by the embodiments of the disclosure where there are shown and described preferred embodiments of this disclosure, simply by way of illustration of modes best suited to carry out the disclosure.

### BRIEF DESCRIPTION OF THE DRAWINGS

FIG. 1A is a schematic cross-sectional view of a display apparatus according to a first embodiment of the disclosure.

FIG. 1B is a schematic cross-sectional view of a modified embodiment of the display apparatus according to a first embodiment of the disclosure.

FIG. 2 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 1A.

FIG. 3A and FIG. 3B are light distribution diagrams of the display apparatus of FIG. 1A operating in different display modes.

FIG. 4A and FIG. 4B are light distribution diagrams of a display apparatus of a comparative example operating in different display modes.

FIG. 5 is a schematic cross-sectional view of a display apparatus according to a second embodiment of the disclosure.

FIG. 6 is a schematic diagram illustrating the configuration relationship between axial directions of absorption axes of polarizers, alignment directions of alignment layers and axial directions of optical axes of phase retardation films of FIG. 5.

FIG. 7 is a schematic cross-sectional view of a display apparatus according to a third embodiment of the disclosure.

FIG. 8 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 7.

FIG. 9 is a schematic cross-sectional view of a display apparatus according to a fourth embodiment of the disclosure.

FIG. 10 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 9.

FIG. 11 is a schematic cross-sectional view of a display apparatus according to a fifth embodiment of the disclosure.

FIG. 12 is a schematic diagram illustrating the configuration relationship between axial directions of absorption axes of polarizers, alignment directions of alignment layers and axial directions of optical axes of phase retardation films of FIG. 11.

FIG. 13 is a schematic cross-sectional view of a display apparatus according to a sixth embodiment of the disclosure.

FIG. 14 is a schematic diagram illustrating the configuration relationship between axial directions of absorption axes of polarizers, alignment directions of alignment layers and an axial direction of an optical axis of a phase retardation film of FIG. 13.

FIG. 15 is a schematic cross-sectional view of a display apparatus according to a seventh embodiment of the disclosure.

FIG. 16 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 15.

FIG. 17 is a schematic cross-sectional view of a display apparatus according to an eighth embodiment of the disclosure.

FIG. 18 is a schematic diagram illustrating the configuration relationship between axial directions of absorption axes of polarizers, alignment directions of alignment layers and an axial direction of an optical axis of a phase retardation film of FIG. 17.

FIG. 19 is a schematic cross-sectional view of a display apparatus according to a ninth embodiment of the disclosure.

FIG. 20 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 19.

FIG. 21 is a schematic cross-sectional view of a display apparatus according to a tenth embodiment of the disclosure.

FIG. 22 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 21.

FIG. 23 is a schematic cross-sectional view of a display apparatus according to an eleventh embodiment of the disclosure.

FIG. 24 is a schematic diagram illustrating the configuration relationship between axial directions of absorption axes of polarizers, alignment directions of alignment layers and an axial direction of an optical axis of a phase retardation film of FIG. 23.

FIG. 25 is a schematic cross-sectional view of a display apparatus according to a twelfth embodiment of the disclosure.

FIG. 26 is a schematic diagram illustrating the configuration relationship between axial directions of absorption axes of polarizers, alignment directions of alignment layers and an axial direction of an optical axis of a phase retardation film of FIG. 25.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as "top," "bottom," "front," "back," etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

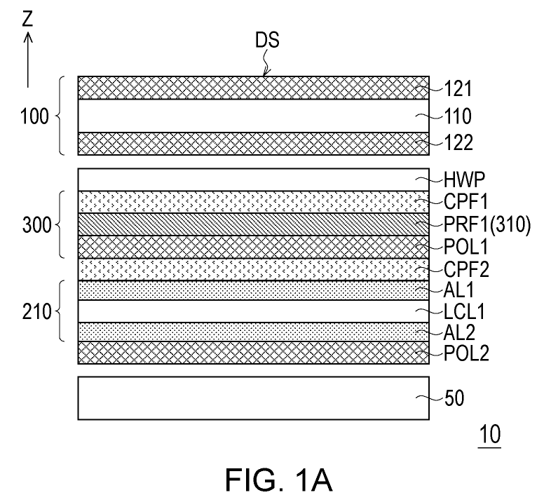

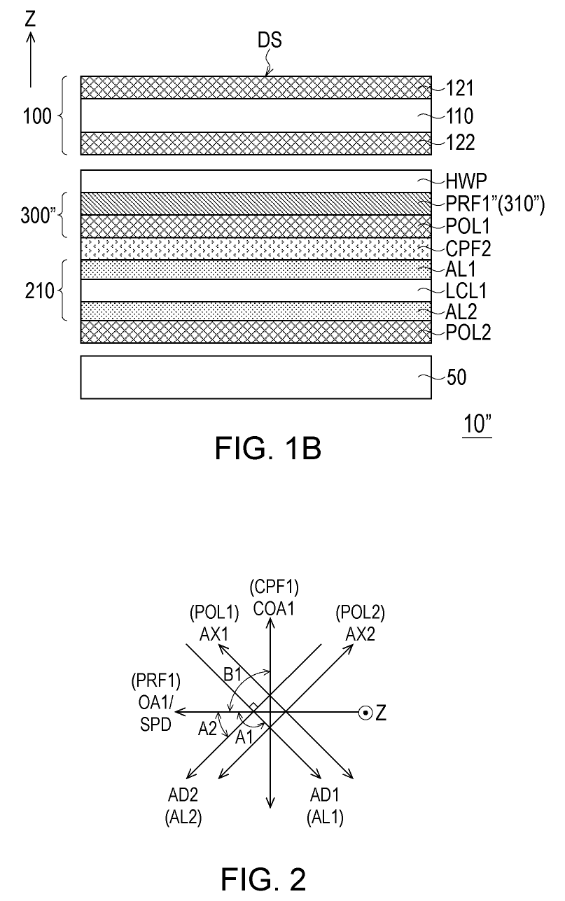

FIG. 1A is a schematic cross-sectional view of a display apparatus according to a first embodiment of the disclosure. FIG. 1B is a schematic cross-sectional view of a modified embodiment of the display apparatus according to a first embodiment of the disclosure. FIG. 2 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 1A. It is particularly noted that the angular configuration relationship in FIG. 2 is, for example, the angular configuration relationship of each direction in the top view of the display apparatus 10, and the angular configuration relationship diagrams in the disclosure can be understood in a similar manner and will not be elaborated.

Referring to FIG. 1A, a display apparatus 10 includes a display panel 100 and a first electrically controlled phase retarder 210. The first electrically controlled phase retarder 210 is arranged to overlap the display panel 100 along a direction Z, and the direction Z is, for example, perpendicular to a display surface DS of the display panel 100, and the display surface DS is suitable for displaying images. The display panel 100 is, for example, a liquid crystal display panel, which may include a polarizer 121, a polarizer 122, and an electrically controlled liquid crystal cell 110 disposed between the polarizer 121 and the polarizer 122, but the disclosure is not limited thereto. In other embodiments, the display panel 100 may also be other suitable non-self-luminous display panel. Accordingly, in the embodiment, the display apparatus 10 may further include a backlight module 50. The backlight module 50 is disposed on one side of the first electrically controlled phase retarder 210 facing away from the display panel 100 (i.e., the first electrically controlled phase retarder 210 is disposed between the display panel 100 and the backlight module 50), and is used to provide the illumination light required for the display panel 100 during display. The backlight module 50 is, for example, an edge-lit backlight module (which may include one or two light guide plates) or a back-lit backlight module.

The first electrically controlled phase retarder 210 may include a first substrate (not shown), a second substrate (not shown), a first alignment layer AL1, a second alignment layer AL2 and a first liquid crystal layer LCL1. The first alignment layer AL1 and the second alignment layer AL2 are respectively disposed on the first substrate and the second substrate. It is particularly noted that, for clarity, the first substrate and the second substrate are omitted in the drawing. The first alignment layer AL1 is located between the first substrate and the first liquid crystal layer LCL1. The second alignment layer AL2 is located between the second substrate and the first liquid crystal layer LCL1. The first liquid crystal layer LCL1 is disposed between the first alignment layer AL1 and the second alignment layer AL2.

It is particularly noted that the two alignment layers of the electrically controlled phase retarder are configured to determine the alignment direction (alignment state) of the liquid crystal layer in a natural state (e.g., not subjected to an electric field). In order to drive the liquid crystal layer, the electrically controlled phase retarder may further include two electrode layers (not shown) respectively arranged on opposite sides of the liquid crystal layer. When the two electrode layers are activated and have a potential difference, an alignment of a plurality of liquid crystal molecules (not shown) of the liquid crystal layer will be changed by the electric field formed between the two electrode layers.

Referring to FIG. 1A and FIG. 2, the first electrically controlled phase retarder 210 may have a single-sided anti-peeping direction SPD perpendicular to the direction Z. In the embodiment, the single-sided anti-peeping direction SPD is, for example, directed to the left side of FIG. 2. It should first be noted that the first electrically controlled phase retarder 210 allows the display apparatus 10 to have an anti-peeping effect within a viewing angle range on one side along the single-sided anti-peeping direction SPD, that is, it restricts the light emission of the display apparatus 10 within a specific viewing angle range on the left side of FIG. 2.

For example, in the embodiment, a first alignment direction AD1 of the first alignment layer AL1 of the first electrically controlled phase retarder 210 is perpendicular to a second alignment direction AD2 of the second alignment layer AL2. That is, the first liquid crystal layer LCL1 of the first electrically controlled phase retarder 210 of the embodiment is driven in a twisted-nematic (TN) mode, and an included angle between the first alignment direction AD1 and the second alignment direction AD2 is 90 degrees. In the embodiment, an included angle between the single-sided anti-peeping direction SPD and each of the first alignment direction AD1 and the second alignment direction AD2 is 45 degrees or 135 degrees. For example, an included angle A1 between the first alignment direction AD1 and the single-sided anti-peeping direction SPD can be 135 degrees, and an included angle A2 between the second alignment direction AD2 and the single-sided anti-peeping direction SPD can be 45 degrees.

The maximum phase retardation of the first liquid crystal layer LCL1 is, for example, 1.08 μm. The aforementioned maximum phase retardation is, for example, the product value of the difference between the ordinary-ray refractive index and the extraordinary-ray refractive index of the liquid crystal molecules (not shown) of the liquid crystal layer and a thickness of the liquid crystal layer. It is particularly noted that, compared to the liquid crystal layer used in a general liquid crystal display panel, the liquid crystal layer of the electrically controlled phase retarder of the disclosure has a significantly larger maximum phase retardation.

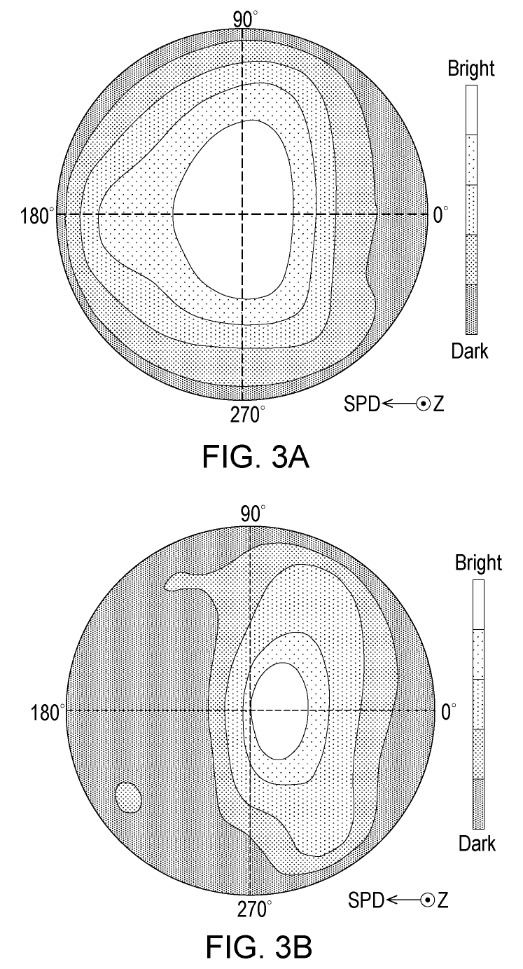

It should be noted that in FIG. 2, the azimuth angle of the single-sided anti-peeping direction SPD is, for example, 180 degrees (as shown in FIG. 3B). Therefore, the azimuth angle of a direction (i.e., a direction toward the right side in FIG. 2) opposite to the single-sided anti-peeping direction SPD may be 0 degrees. The azimuth angle of a direction perpendicular to the single-sided anti-peeping direction SPD and facing upward in FIG. 2 may be 90 degrees. The azimuth angle of a direction perpendicular to the single-sided anti-peeping direction SPD and facing downward in FIG. 2 may be 270 degrees.

It should first be noted that in order to suppress the light emission of the display apparatus 10 at a large viewing angle (e.g., a viewing angle greater than 50 degrees, wherein a normal viewing angle is defined as 0 degrees) on the non-anti-peeping side, the display apparatus 10 is further provided with a polarization modulator 300. In the embodiment, the polarization modulator 300 can be disposed between the display panel 100 and the first electrically controlled phase retarder 210, and includes a polarizer POL1 and a polarization modulation unit 310. The polarization modulation unit 310 includes a first phase retardation film PRF1. The polarizer POL1 may be disposed between the first phase retardation film PRF1 and the first electrically controlled phase retarder 210, but the disclosure is not limited thereto. The polarizer POL1 has an absorption axis AX1. The first phase retardation film PRF1 has a first optical axis OA1. An orthographic projection of the first optical axis OA1 on the display surface DS of the display panel 100 is not parallel and not perpendicular to an orthographic projection of the absorption axis AX1 on the display surface DS. For example, in the embodiment, the first optical axis OA1 of the first phase retardation film PRF1 may be parallel to the single-sided anti-peep direction SPD of the first electrically controlled phase retarder 210. More specifically, the azimuth angle of the orthographic projection of the first optical axis OA1 in FIG. 2 is 180 degrees, and an included angle between the first optical axis OA1 and the absorption axis AX1 is, for example, greater than or equal to 30 degrees and less than or equal to 60 degrees. On the other hand, an absorption axis (not shown) of the polarizer 121 of the display panel 100 may be parallel to the first optical axis OA1 of the first phase retardation film PRF1. An absorption axis (not shown) of the polarizer 122 may be perpendicular to the first optical axis OA1 of the first phase retardation film PRF1.

The first phase retardation film PRF1 is, for example, an O-plate and is made of a liquid crystal material. For example, if the liquid crystal material of the first phase retardation film PRF1 is a positive liquid crystal, its in-plane phase retardation (R0) is preferably in a range of 100 nm to 400 nm, and its out-of-plane phase retardation (Rth) is preferably in a range of -30 nm to -100 nm. If the liquid crystal material of the first phase retardation film PRF1 is a negative liquid crystal, its in-plane phase retardation is preferably in a range of -50 nm to -150 nm, and its out-of-plane phase retardation is preferably in a range of 100 nm to 380 nm.

The aforementioned out-of-plane phase retardation can be defined by the following relationship: Rth=[(nx+ny)/2-nz]*d, where nx and ny are the two refractive indices of the phase retardation film (e.g., the liquid crystal material layer) along two directions parallel to a film surface thereof and perpendicular to each other, nz is the refractive index of the phase retardation film along a direction perpendicular to the film surface, and d is a film thickness of the phase retardation film. The aforementioned in-plane phase retardation can be defined by the following relationship: R0=(nx-ny)*d.

In the embodiment, the display apparatus 10 further includes a polarizer POL2 disposed on one side of the first electrically controlled phase retarder 210 facing away from the polarization modulator 300. That is, the polarizer POL2 is located between the first electrically controlled phase retarder 210 and the backlight module 50. An absorption axis AX2 of the polarizer POL2 is perpendicular to the absorption axis AX1 of the polarizer POL1. Preferably, the absorption axis AX1 of the polarizer POL1 may be parallel to the first alignment direction AD1 of the first alignment layer AL1, and the absorption axis AX2 of the polarizer POL2 may be parallel to the second alignment direction AD2 of the second alignment layer AL2. In FIG. 2, the azimuth angle of the first alignment direction AD1 is 315 degrees, and the azimuth angle of the second alignment direction AD2 is 225 degrees. However, the disclosure is not limited thereto. In other embodiments, the absorption axis AX1 may be perpendicular to the first alignment direction AD1, and the absorption axis AX2 may be perpendicular to the second alignment direction AD2.

It is particularly noted that the configuration relationship between the first alignment direction AD1, the second alignment direction AD2, the axial direction of the absorption axis AX1 and the axial direction of the absorption axis AX2 can define the aforementioned single-sided anti-peeping direction SPD. In other words, the first electrically controlled phase retarder 210 disposed between the polarizer POL1 and the polarizer POL2 allows the display apparatus 10 to have an electrically switchable single-sided anti-peeping effect.

In order to ensure that the brightness of the display apparatus 10 at a normal viewing angle is not reduced due to the arrangement of the polarization modulation unit 310, the sum of the in-plane phase retardation of the polarization modulation unit 310 must be greater than or equal to -50 nm and less than or equal to 50 nm. For example, in the embodiment, the polarization modulation unit 310 may further include a first compensation film CPF1. The first compensation film CPF1 has a compensation optical axis COA1, and the compensation optical axis COA1 is not parallel to and not perpendicular to the absorption axis AX1 of the polarizer POL1. More specifically, an axial direction of the compensation optical axis COA1 may be perpendicular to the axial direction of the first optical axis OA1 of the first phase retardation film PRF1, that is, an included angle B1 between the compensation optical axis COA1 and the first optical axis OA1 is 90 degrees. In other embodiments, the included angle B1 is, for example, greater than or equal to 80 degrees and less than or equal to 100 degrees. In the embodiment, the sum of the in-plane phase retardations of the first phase retardation film PRF1 and the first compensation film CPF1 is greater than or equal to -50 nm and less than or equal to 50 nm, which may ensure that the brightness of the display apparatus at a normal viewing angle is not affected due to the arrangement of the polarization modulator 300. In a display apparatus 10” of another modified embodiment, as shown in FIG. 1B, if the in-plane phase retardation of the first phase retardation film PRF1” of the polarization modulation unit 310” of the polarization modulator 300” is greater than or equal to -50 nm and less than or equal to 50 nm, the first compensation film CPF1 as shown in FIG. 1A may not be provided. Specifically , the sum of the in-plane phase retardation of the polarization modulation unit must be greater than or equal to -50 nm and less than or equal to 50 nm.

In the embodiment, the display apparatus 10 may further include a second compensation film CPF2 and a half-wave plate HWP. The second compensation film CPF2 is disposed between the first electrically controlled phase retarder 210 and the polarizer POL1 (or the polarization modulator 300) and is configured to compensate for the first electrically controlled phase retarder 210, but the disclosure is not limited thereto. The out-of-plane phase retardation of the second compensation film CPF2 is, for example, -150 nm. The half-wave plate HWP is disposed between the display panel 100 and the polarization modulator 300. The azimuth angle of an axial direction of an optical axis of the half-wave plate HWP is, for example, 112.5 degrees in FIG. 2, to adjust the polarization direction of a light beam.

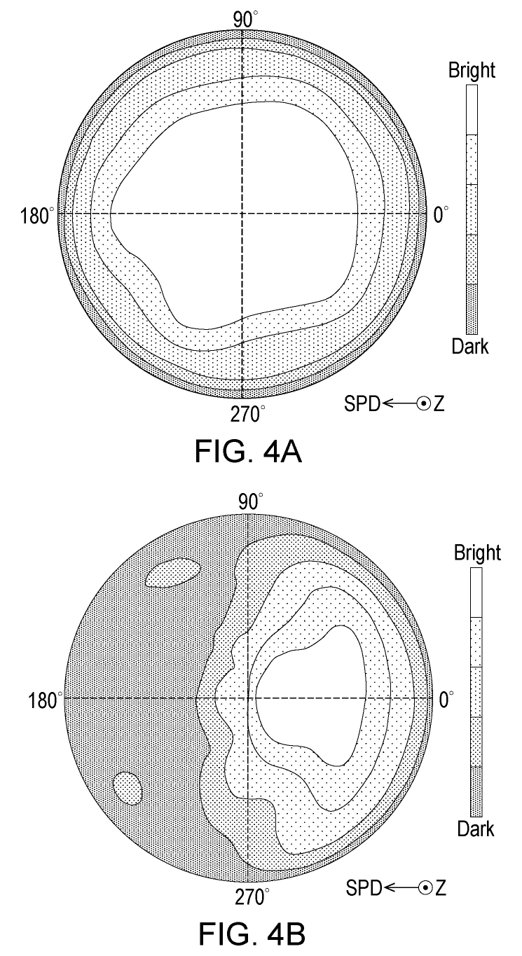

FIG. 3A and FIG. 3B are light distribution diagrams of the display apparatus of FIG. 1A operating in different display modes. FIG. 4A and FIG. 4B are light distribution diagrams of a display apparatus of a comparative example operating in different display modes. Compared to the display apparatus 10 of the embodiment, the display apparatus of the comparative example is not provided with the polarization modulator 300.

For example, when the first electrically controlled phase retarder 210 is disabled, the display apparatus 10 is operated in a sharing mode, and the light emission distribution of the display apparatus 10 is shown in FIG. 3A. Compared with the light emission distribution of the display apparatus of the comparative example operated in the sharing mode (as shown in FIG. 4A), the light emission of the display apparatus 10 of the embodiment at large viewing angles on the right side of FIG. 3A can be effectively suppressed. Similarly, when the first electrically controlled phase retarder 210 is enabled, the display apparatus 10 is operated in an anti-peeping mode, and the light emission distribution of the display apparatus 10 is shown in FIG. 3B. Compared with the light emission distribution of the display apparatus of the comparative example operated in the anti-peeping mode (as shown in FIG. 4B), the light emission of the display apparatus 10 of the embodiment on the non-anti-peeping side (e.g., the right side in FIG. 3B, i.e., the side of an azimuth angle of 0 degrees) can be effectively suppressed. That is, whether in the sharing mode or the anti-peeping mode, the light emission of the display apparatus 10 at large viewing angles on the right side in FIG. 3A and FIG. 3B can be suppressed by the arrangement of the polarization modulator 300.

Based on the above-mentioned optical filtering characteristics, the display apparatus 10 of the embodiment is suitable for use in an in-vehicle personal display. For example, taking a left-hand drive vehicle as an example, the driver's seat of the vehicle can be arranged within the negative viewing angle range (e.g., the range on the left half side in FIG. 3B) of the display apparatus 10, and the co-pilot seat (i.e., the passenger front seat) of the vehicle can be arranged within the positive viewing angle range (e.g., the range on the right half side in FIG. 3B) of the display apparatus 10. When the vehicle is in motion, the display apparatus 10 can be switched to the aforementioned anti-peeping mode. At the time, the optical filtering effect of the first electrically controlled phase retarder 210, the polarizer POL1 and the polarizer POL2 on the driver's side can prevent the driver from being disturbed by the display light emitted by the display apparatus 10. On the other hand, the optical filtering effect of the polarization modulator 300 on the window side of the co-pilot seat can ensure that the driver is not affected by the display light reflected by the window. Accordingly, the safety of the vehicle during nighttime driving may be greatly improved.

Some other embodiments are provided below to describe the disclosure in detail, where the same reference numerals denote the same or like components, and descriptions of the same technical contents are omitted. The aforementioned embodiment may be referred for descriptions of the omitted parts, and detailed descriptions thereof are not repeated in the following embodiment.

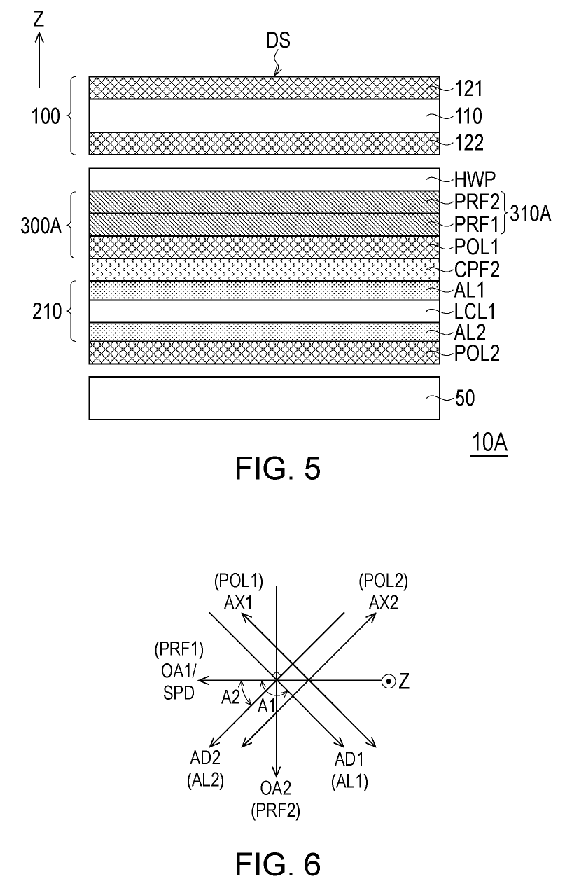

FIG. 5 is a schematic cross-sectional view of a display apparatus according to a second embodiment of the disclosure. FIG. 6 is a schematic diagram illustrating the configuration relationship between axial directions of absorption axes of polarizers, alignment directions of alignment layers and axial directions of optical axes of phase retardation films of FIG. 5. Referring to FIG. 5 and FIG. 6, compared to the display apparatus 10 of FIG. 1A, the polarization modulation unit 310A of the polarization modulator 300A of the display apparatus 10A of the embodiment may further include a second phase retardation film PRF2, and does not include the first compensation film CPF1. The second phase retardation film PRF2 is disposed between the first phase retardation film PRF1 and the display panel 100.

It should be noted that an orthographic projection of a second optical axis OA2 of the second phase retardation film PRF2 on the display surface DS is perpendicular to the orthographic projection of the first optical axis OA1 of the first phase retardation film PRF1 on the display surface DS. More specifically, in the embodiment, the azimuth angle of an axial direction of the second optical axis OA2 of the second phase retardation film PRF2 in FIG. 6 is, for example, 270 degrees, that is, the second optical axis OA2 may be parallel to the compensation optical axis COA1 of the first compensation film CPF1 in FIG. 2.

The in-plane phase retardation of each of the first phase retardation film PRF1 and the second phase retardation film PRF2 is, for example, -50 nm, and the out-of-plane phase retardation of each is, for example, 105 nm, but the disclosure is not limited thereto. In the embodiment, the sum of the in-plane phase retardations of the first phase retardation film PRF1 and the second phase retardation film PRF2 may be greater than or equal to -50 nm and less than or equal to 50 nm. In other words, the compensation effect of the second phase retardation film PRF2 on the in-plane phase retardation of the polarization modulator 300A is similar to that of the first compensation film CPF1 in FIG. 2. Therefore, the polarization modulator 300A of the embodiment may omit the arrangement of the first compensation film CPF1 in FIG. 2. Specifically, the sum of the in-plane phase retardation of the polarization modulation unit 310A is greater than or equal to -50 nm and less than or equal to 50 nm.

On the other hand, the polarization modulator 300A may further suppress the light emission of the display apparatus 10A at large viewing angles on another non-anti-peeping side (e.g., the upper side in FIG. 3B, i.e., the side of an azimuth angle of 90 degrees) due to the provision of the second phase retardation film PRF2. Therefore, when the display apparatus 10A is used in an in-vehicle personal display, the windshield of the vehicle is located within the viewing angle range (e.g., the range of the upper half side in FIG. 3B) above the display apparatus. When the vehicle is in motion at night, the suppression effect of the polarization modulator 300A on the light emission of the display apparatus 10A at large viewing angles above the display apparatus 10A may ensure that the driver or the passenger in the co-pilot seat (i.e., the passenger front seat) is not affected by the display light reflected by the windshield, thereby improving the viewing quality of the display apparatus 10A.

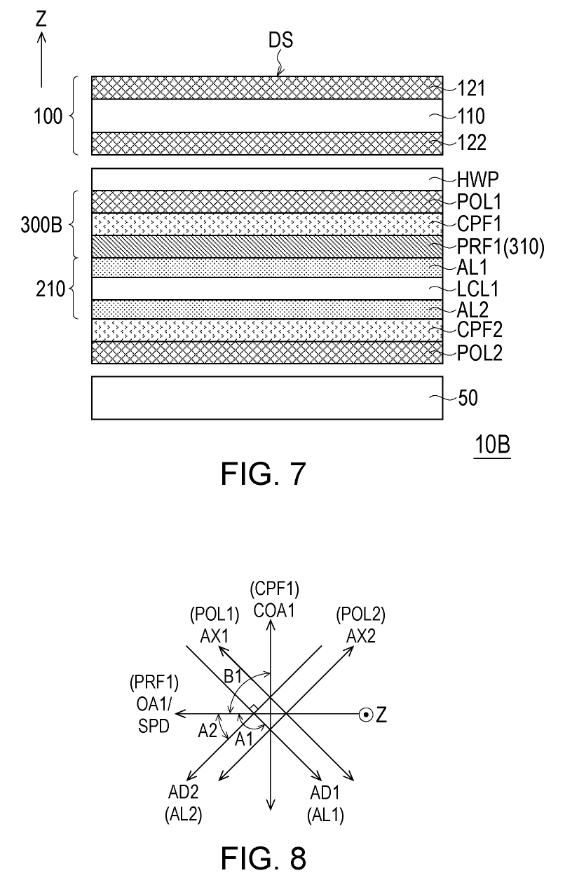

FIG. 7 is a schematic cross-sectional view of a display apparatus according to a third embodiment of the disclosure. FIG. 8 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 7. Referring to FIG. 7 and FIG. 8, the difference between a display apparatus 10B of the embodiment and the display apparatus 10 of FIG. 1A lies in that the arrangement order of the film layers of the polarization modulator is different.

For example, in the display apparatus 10B of the embodiment, the first phase retardation film PRF1 of the polarization modulator 300B is disposed between the first electrically controlled phase retarder 210 and the polarizer POL1, and the first compensation film CPF1 is disposed between the polarizer POL1 and the first phase retardation film PRF1. It is particularly noted that, in the embodiment, the second compensation film CPF2 may be disposed between the polarizer POL2 and the first electrically controlled phase retarder 210. In order to ensure the anti-peeping effect of the display apparatus 10B operated in the anti-peeping mode, the out-of-plane phase retardation of the second compensation film CPF2 may be greater than or equal to -350 nm and less than or equal to -300 nm, and the sum of the in-plane phase retardations of the first compensation film CPF1 and the second compensation film CPF2 must be greater than or equal to -50 nm and less than or equal to 50 nm. Similarly, if the in-plane phase retardation of the first phase retardation film PRF1 is greater than or equal to -50 nm and less than or equal to 50 nm, the first compensation film CPF1 may not be provided. Specifically, the sum of the in-plane phase retardation of the polarization modulation unit must be greater than or equal to -50 nm and less than or equal to 50 nm.

It is particularly noted that, in the embodiment, if the first phase retardation film PRF1 is made of negative liquid crystals, its in-plane phase retardation (R0) is preferably in a range of -50 nm to -100 nm. Accordingly, the suppression effect of the display apparatus 10B on the window reflection of the car can be optimized. If the first phase retardation film PRF1 is made of positive liquid crystals, its in-plane phase retardation is preferably in a range of 50 nm to 100 nm. Since the out-of-plane phase retardation of the first phase retardation film PRF1 made of the positive liquid crystals is negative, the second compensation film CPF2 may not be provided.

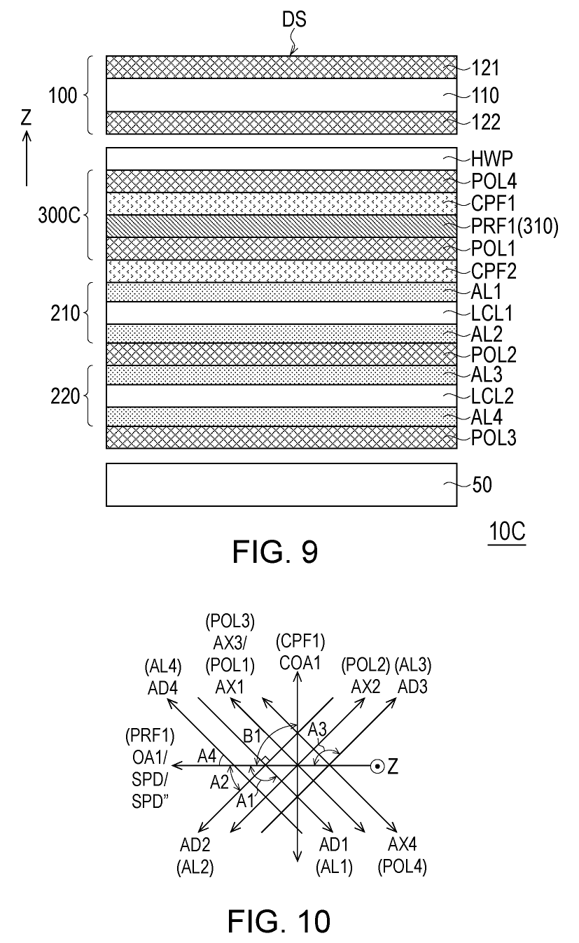

FIG. 9 is a schematic cross-sectional view of a display apparatus according to a fourth embodiment of the disclosure. FIG. 10 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 9. Referring to FIG. 9 and FIG. 10, the difference between a display apparatus 10C of the embodiment and the display apparatus 10 of FIG. 1A lies in that the number of electrically controlled phase retarder is different.

Specifically, the display apparatus 10C may further include a second electrically controlled phase retarder 220 overlapping the display panel 100 along the direction Z. In the embodiment, the second electrically controlled phase retarder 220 is located between the first electrically controlled phase retarder 210 and the backlight module 50. The polarizer POL2 is located between the first electrically controlled phase retarder 210 and the second electrically controlled phase retarder 220. A polarizer POL3 is provided on one side of the second electrically controlled phase retarder 220 facing away from the first electrically controlled phase retarder 210.

Similar to the first electrically controlled phase retarder 210, the second electrically controlled phase retarder 220 may include a third substrate (not shown), a fourth substrate (not shown), a third alignment layer AL3, a fourth alignment layer AL4 and a second liquid crystal layer LCL2. The third alignment layer AL3 and the fourth alignment layer AL4 are disposed on the third substrate and the fourth substrate, respectively. The third alignment layer AL3 is located between the third substrate and the second liquid crystal layer LCL2. The fourth alignment layer AL4 is located between the fourth substrate and the second liquid crystal layer LCL2. The second liquid crystal layer LCL2 is disposed between the third alignment layer AL3 and the fourth alignment layer AL4. The maximum phase retardation of the second liquid crystal layer LCL2 is, for example, 1.08 μm.

For example, in the embodiment, a third alignment direction AD3 of the third alignment layer AL3 of the second electrically controlled phase retarder 220 is perpendicular to a fourth alignment direction AD4 of the fourth alignment layer AL4. That is, the second liquid crystal layer LCL2 of the second electrically controlled phase retarder 220 of the embodiment is driven in a twisted nematic (TN) mode, and an included angle between the third alignment direction AD3 and the fourth alignment direction AD4 is 90 degrees. In the embodiment, an included angle between a single-sided anti-peeping direction SPD” of the second electrically controlled phase retarder 220 and each of the third alignment direction AD3 and the fourth alignment direction AD4 is 45 degrees or 135 degrees. For example, an included angle A3 between the third alignment direction AD3 and the single-sided anti-peeping direction SPD” (or the single-sided anti-peeping direction SPD) can be 135 degrees, and an included angle A4 between the fourth alignment direction AD4 and the single-sided anti-peeping direction SPD” can be 45 degrees.

The second electrically controlled phase retarder 220 may have the single-sided anti-peeping direction SPD” perpendicular to the direction Z. In the embodiment, the single-sided anti-peeping direction SPD” is, for example, a direction toward the left side in FIG. 10. That is, the single-sided anti-peeping direction SPD” of the second electrically controlled phase retarder 220 is parallel to the single-sided anti-peeping direction SPD of the first electrically controlled phase retarder 210. Therefore, the provision of the second electrically controlled phase retarder 220 may further enhance the anti-peeping effect of the display apparatus 10C in the single-sided anti-peeping direction SPD.

It is particularly noted that, in the embodiment, the third alignment layer AL3 of the second electrically controlled phase retarder 220 is disposed between the first liquid crystal layer LCL1 and the second liquid crystal layer LCL2. The third alignment direction AD3 of the third alignment layer AL3 may be parallel to the absorption axis AX2 of the polarizer POL2, and the fourth alignment direction AD4 of the fourth alignment layer AL4 may be parallel to the absorption axis AX3 of the polarizer POL3. The configuration relationship between the third alignment direction AD3, the fourth alignment direction AD4, the axial direction of the absorption axis AX2, and the axial direction of the absorption axis AX3 may define the aforementioned single-sided anti-peeping direction SPD”. In other words, the second electrically controlled phase retarder 220 disposed between the polarizer POL3 and the polarizer POL2 allows the display apparatus 10C to have an electrically switchable single-sided anti-peeping effect.

From the arrangement of the alignment layers of the first electrically controlled phase retarder 210 and the second electrically controlled phase retarder 220, it can be known that the handedness of the second liquid crystal layer LCL2 may be different from the handedness of the first liquid crystal layer LCL1. For example, the first liquid crystal layer LCL1 is composed of left-handed liquid crystals, and the second liquid crystal layer LCL2 is composed of right-handed liquid crystals. Accordingly, the alignment direction of the alignment layer of each of the first electrically controlled phase retarder 210 and the second electrically controlled phase retarder 220 may be parallel to the absorption axis (i.e., the electrically controlled phase retarder is operated in an O-mode architecture) of the adjacent polarizer, which helps to improve the anti-peeping effect and display quality of the display apparatus 10C.

In the embodiment, a polarizer POL4 may be provided on one side of the polarization modulator 300C of the display apparatus 10C facing away from the first electrically controlled phase retarder 210. The first phase retardation film PRF1 and the first compensation film CPF1 are located between the polarizer POL1 and the polarizer POL4. An absorption axis AX4 of the polarizer POL4 may be parallel to the absorption axis AX1 of the polarizer POL1. However, the disclosure is not limited thereto. In other embodiments, in order to improve the utilization rate of light energy, the display apparatus may not be provided with the polarizer POL4. Similarly, if the in-plane phase retardation of the first phase retardation film PRF1 is greater than or equal to -50 nm and less than or equal to 50 nm, the first compensation film CPF1 may not be provided. Specifically, the sum of the in-plane phase retardation of the polarization modulation unit 310 is greater than or equal to -50 nm and less than or equal to 50 nm.

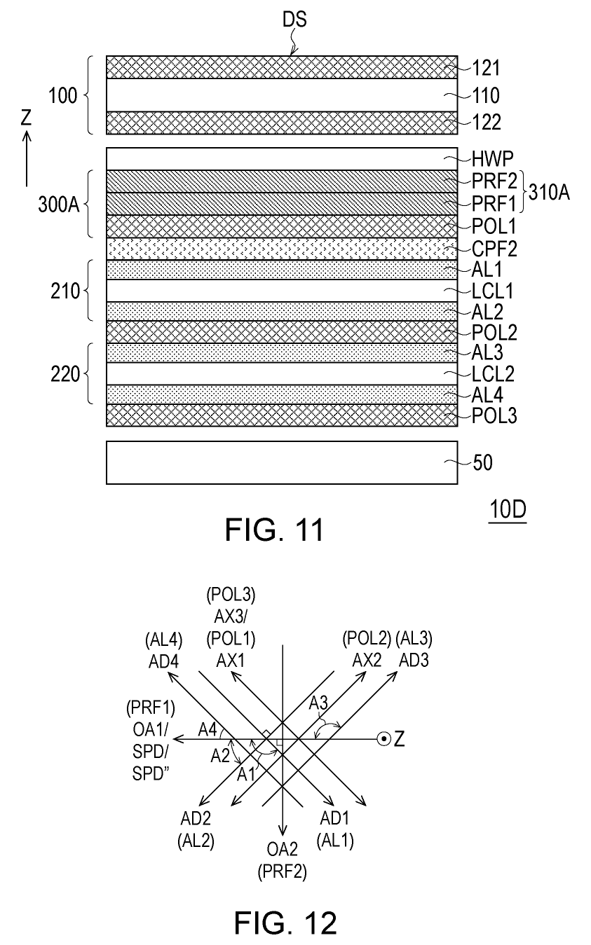

FIG. 11 is a schematic cross-sectional view of a display apparatus according to a fifth embodiment of the disclosure. FIG. 12 is a schematic diagram illustrating the configuration relationship between axial directions of absorption axes of polarizers, alignment directions of alignment layers and axial directions of optical axes of phase retardation films of FIG. 11. Referring to FIG. 11 and FIG. 12, the difference between a display apparatus 10D of the embodiment and the display apparatus 10C of FIG. 9 lies in that the film layer configuration of the polarization modulator is different. Specifically, in the display apparatus 10D of the embodiment, the polarization modulation unit 310A may further include a second phase retardation film PRF2 disposed between the first phase retardation film PRF1 and the display panel 100. In addition, the polarization modulator 300A of the embodiment is not provided with the polarizer POL4 of FIG. 9.

Since the polarization modulator 300A of the embodiment is similar to the polarization modulator 300A of FIG. 5, detailed descriptions can be referred to the relevant paragraphs of the aforementioned embodiments, which will not be described again herein.

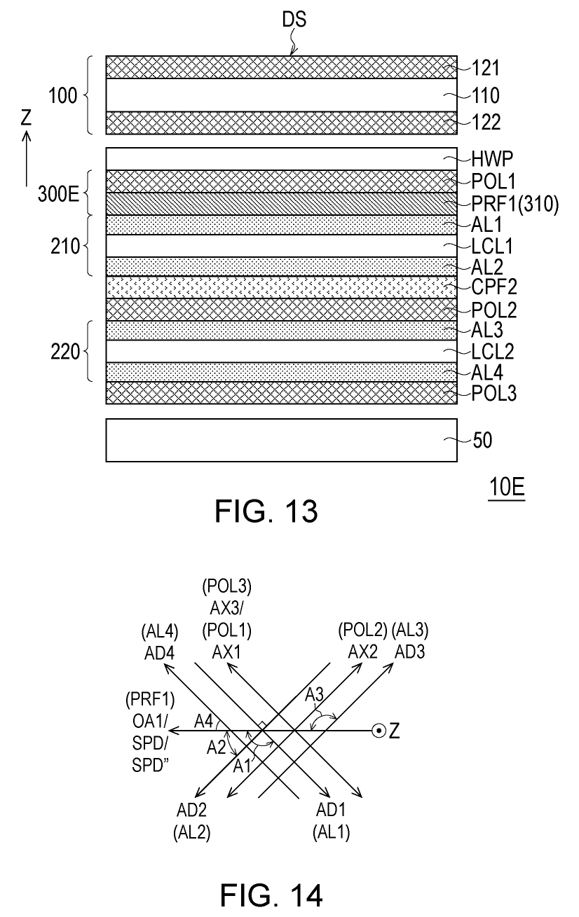

FIG. 13 is a schematic cross-sectional view of a display apparatus according to a sixth embodiment of the disclosure. FIG. 14 is a schematic diagram illustrating the configuration relationship between axial directions of absorption axes of polarizers, alignment directions of alignment layers and an axial direction of an optical axis of a phase retardation film of FIG. 13. Referring to FIG. 13 and FIG. 14, the difference between a display apparatus 10E of the embodiment and the display apparatus 10C of FIG. 9 lies in that the arrangement order of the film layers of the polarization modulator is different.

For example, in the display apparatus 10E of the embodiment, the first phase retardation film PRF1 of the polarization modulator 300E is disposed between the first electrically controlled phase retarder 210 and the polarizer POL1, and the polarization modulator 300E is not provided with the first compensation film CPF1 and the polarizer POL4 of FIG. 9. That is, in the embodiment, the polarization modulator 300E only includes the first phase retardation film PRF1 and the polarizer POL1. It is particularly noted that, in the embodiment, the second compensation film CPF2 may be disposed between the polarizer POL2 and the first electrically controlled phase retarder 210.

Since the technical effect of the polarization modulator 300E of the embodiment on the display apparatus 10E is similar to the technical effect of the polarization modulator 300B of FIG. 7 on the display apparatus 10B, the detailed description can be referred to the relevant paragraphs of the aforementioned embodiments, which will not be described again herein.

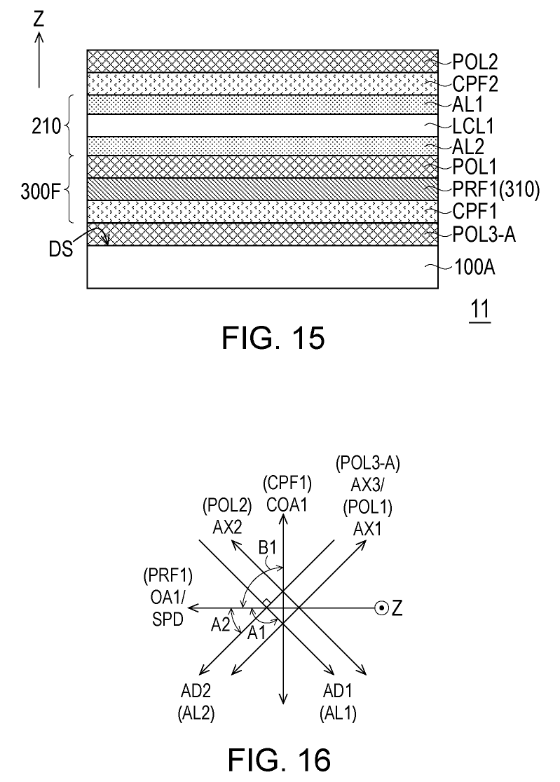

FIG. 15 is a schematic cross-sectional view of a display apparatus according to a seventh embodiment of the disclosure. FIG. 16 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 15. Referring to FIG. 15 and FIG. 16, the main difference between a display apparatus 11 of the embodiment and the display apparatus 10 of FIG. 1A lies in that the type and location of the display panel are different.

Specifically, in the display apparatus 11 of the embodiment, the display panel 100A may be a self-luminous display panel, such as an organic light emitting diode (OLED) display panel, a micro light emitting diode (micro-LED) display panel or a milli light emitting diode (mini-LED) display panel, but the disclosure is not limited thereto.

In the embodiment, the polarization modulator 300F is disposed between the display panel 100A and the first electrically controlled phase retarder 210, and a polarizer POL3-A is further provided between the polarization modulator 300F and the display panel 100A. It is particularly noted that the polarizer POL3-A is, for example, a circular polarizer. The circular polarizer is, for example, composed of a linear polarizer and a quarter-wave plate, and the orthographic projection of an absorption axis AX3 of the linear polarizer on the display surface DS of the display panel 100A may be parallel to the orthographic projection of the absorption axis AX1 of the polarizer POL1 on the display surface DS. That is, the azimuth angle of the absorption axis AX3 in FIG. 16 is 45 degrees. Similarly, if the in-plane phase retardation of the first phase retardation film PRF1 is greater than or equal to -50 nm and less than or equal to 50 nm, the first compensation film CPF1 may not be provided. Specifically, the sum of the in-plane phase retardation of the polarization modulation unit 310 is greater than or equal to -50 nm and less than or equal to 50 nm.

Since the technical effect of the polarization modulator 300F of the embodiment on the display apparatus 11 is similar to the technical effect of the polarization modulator 300 of FIG. 1A on the display apparatus 10, detailed descriptions can be referred to the relevant paragraphs of the aforementioned embodiments, which will not be described again herein.

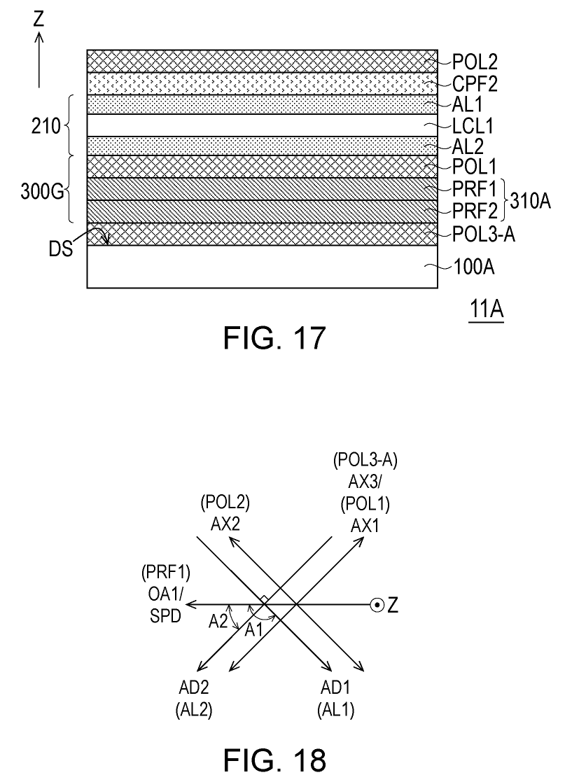

FIG. 17 is a schematic cross-sectional view of a display apparatus according to an eighth embodiment of the disclosure. FIG. 18 is a schematic diagram illustrating the configuration relationship between axial directions of absorption axes of polarizers, alignment directions of alignment layers and an axial direction of an optical axis of a phase retardation film of FIG. 17. Referring to FIG. 17 and FIG. 18, the main difference between a display apparatus 11A of the embodiment and the display apparatus 10A of FIG. 5 lies in that the type and location of the display panel are different.

Specifically, in the display apparatus 11A of the embodiment, the display panel 100A may be a self-luminous display panel. The polarization modulator 300G is disposed between the display panel 100A and the first electrically controlled phase retarder 210, and a polarizer POL3-A is further provided between the polarization modulator 300G and the display panel 100A. It is particularly noted that the polarizer POL3-A is, for example, a circular polarizer. The circular polarizer is, for example, composed of a linear polarizer and a quarter-wave plate, and the orthographic projection of an absorption axis AX3 of the linear polarizer on the display surface DS of the display panel 100A may be parallel to the orthographic projection of the absorption axis AX1 of the polarizer POL1 on the display surface DS. That is, the azimuth angle of the absorption axis AX3 in FIG. 16 is 45 degrees.

Since the technical effect of the polarization modulator 300G of the embodiment on the display apparatus 11A is similar to the technical effect of the polarization modulator 300A of FIG. 5 on the display apparatus 10A, the detailed description can be referred to the relevant paragraphs of the aforementioned embodiments, which will not be described again herein.

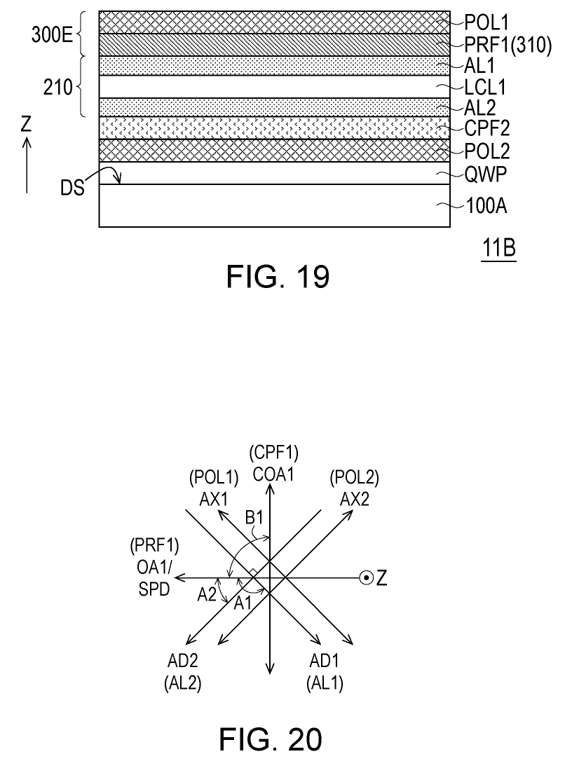

FIG. 19 is a schematic cross-sectional view of a display apparatus according to a ninth embodiment of the disclosure. FIG. 20 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 19. Referring to FIG. 19 and FIG. 20, the main difference between a display apparatus 11B of the embodiment and the display apparatus 10B of FIG. 7 lies in that the type and location of the display panel are different.

Specifically, in the display apparatus 11B of the embodiment, the display panel 100A may be a self-luminous display panel. The polarization modulator 300E is disposed on one side of the first electrically controlled phase retarder 210 facing away from the display panel 100A. That is, the first electrically controlled phase retarder 210 is located between the display panel 100A and the polarization modulator 300E. It is particularly noted that, in the embodiment, the display apparatus 11B is further provided with a quarter-wave plate QWP between the polarizer POL2 and the display panel 100A. The quarter-wave plate QWP and the polarizer POL2 may constitute a circular polarizer.

Since the technical effect of the polarization modulator 300E of the embodiment on the display apparatus 11B is similar to the technical effect of the polarization modulator 300B of FIG. 7 on the display apparatus 10B, the detailed description can be referred to the relevant paragraphs of the aforementioned embodiments, which will not be described again herein.

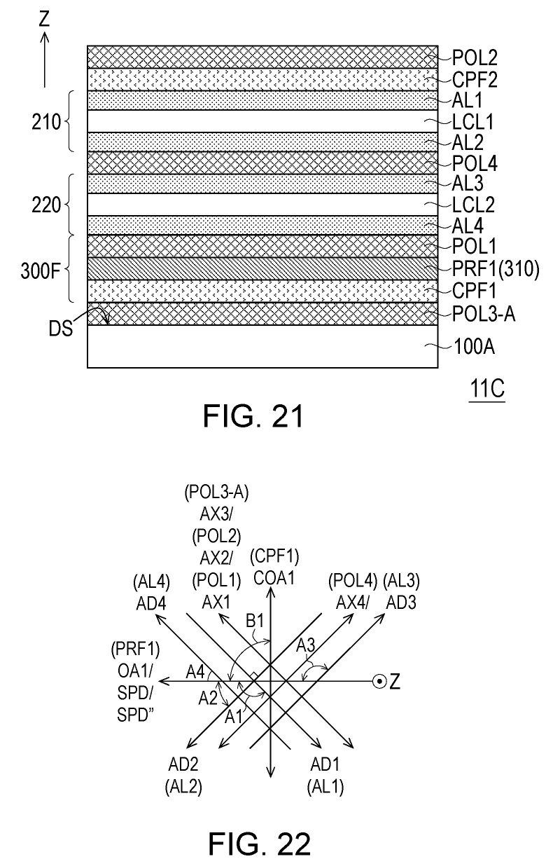

FIG. 21 is a schematic cross-sectional view of a display apparatus according to a tenth embodiment of the disclosure. FIG. 22 is a schematic diagram illustrating the configuration relationship between axial directions of absorption axes of polarizers, alignment directions of alignment layers, an axial direction of a compensation optical axis of a compensation film and an axial direction of an optical axis of a phase retardation film of FIG. 21. Referring to FIG. 21 and FIG. 22, the main difference between a display apparatus 11C of the embodiment and the display apparatus 10C of FIG. 9 lies in that the type and location of the display panel are different.

Specifically, the display panel 100A of the embodiment may be a self-luminous display panel. In the embodiment, the polarization modulator 300F is disposed between the display panel 100A and the second electrically controlled phase retarder 220, and a polarizer POL3-A is further provided between the polarization modulator 300F and the display panel 100A. It is particularly noted that the polarizer POL3-A is, for example, a circular polarizer. The circular polarizer is, for example, composed of a linear polarizer and a quarter-wave plate, and the orthographic projection of the absorption axis AX3 of the linear polarizer on the display surface DS of the display panel 100A may be parallel to the orthographic projection of the absorption axis AX1 of the polarizer POL1 on the display surface DS. That is, the azimuth angle of the absorption axis AX3 in FIG. 22 is 135 degrees. In addition, the polarization modulator 300F is not provided with the polarizer POL4 of FIG. 9.

Since the technical effect of the polarization modulator 300F of the embodiment on the display apparatus 11C is similar to the technical effect of the polarization modulator 300 of FIG. 1A on the display apparatus 10, the detailed description can be referred to the relevant paragraphs of the aforementioned embodiments, which will not be described again herein. Similarly, if the in-plane phase retardation of the first phase retardation film PRF1 is greater than or equal to -50 nm and less than or equal to 50 nm, the first compensation film CPF1 may not be provided. Specifically, the sum of the in-plane phase retardation of the polarization modulation unit 310 is greater than or equal to -50 nm and less than or equal to 50 nm.

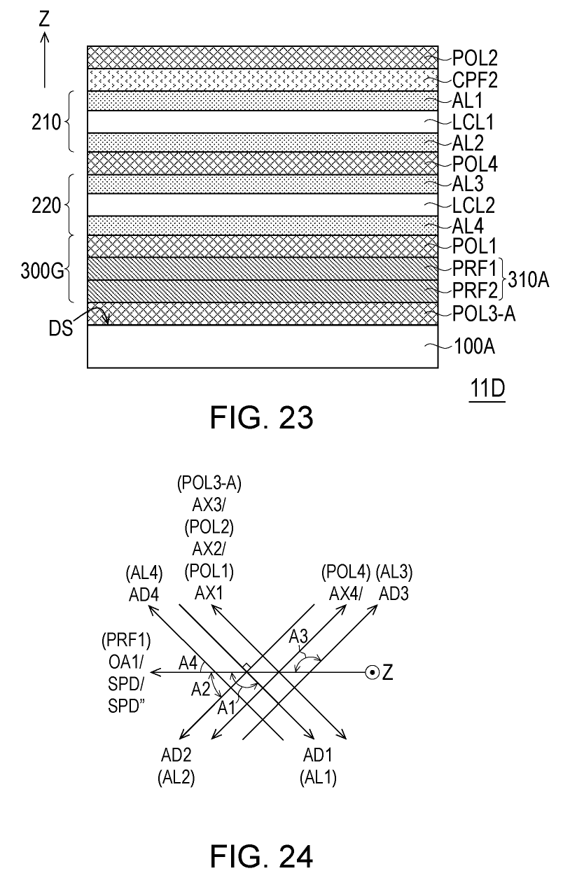

FIG. 23 is a schematic cross-sectional view of a display apparatus according to an eleventh embodiment of the disclosure. FIG. 24 is a schematic diagram illustrating the configuration relationship between axial directions of absorption axes of polarizers, alignment directions of alignment layers and an axial direction of an optical axis of a phase retardation film of FIG. 23. Referring to FIG. 23 and FIG. 24, the difference between a display apparatus 11D of the embodiment and the display apparatus 10D of FIG. 11 lies in that the type and location of the display panel are different.

Specifically, in the display apparatus 11D of the embodiment, the display panel 100A may be a self-luminous display panel. The polarization modulator 300G is disposed between the display panel 100A and the second electrically controlled phase retarder 220, and a polarizer POL3-A is further provided between the polarization modulator 300G and the display panel 100A. It is particularly noted that the polarizer POL3-A is, for example, a circular polarizer. The circular polarizer is composed of, for example, a linear polarizer and a quarter-wave plate, and the orthographic projection of the absorption axis AX3 of the linear polarizer on the display surface DS of the display panel 100A may be parallel to the orthographic projection of the absorption axis AX1 of the polarizer POL1 on the display surface DS. That is, the azimuth angle of the absorption axis AX3 in FIG. 24 is 135 degrees.

Since the technical effect of the polarization modulator 300G of the embodiment on the display apparatus 11D is similar to the technical effect of the polarization modulator 300A of FIG. 5 on the display apparatus 10A, the detailed description can be referred to the relevant paragraphs of the aforementioned embodiments, which will not be described again herein. Similarly, if the in-plane phase retardation of the first phase retardation film PRF1 is greater than or equal to -50 nm and less than or equal to 50 nm, the first compensation film CPF1 may not be provided. Specifically, the sum of the in-plane phase retardation of the polarization modulation unit 310A is greater than or equal to -50 nm and less than or equal to 50 nm.

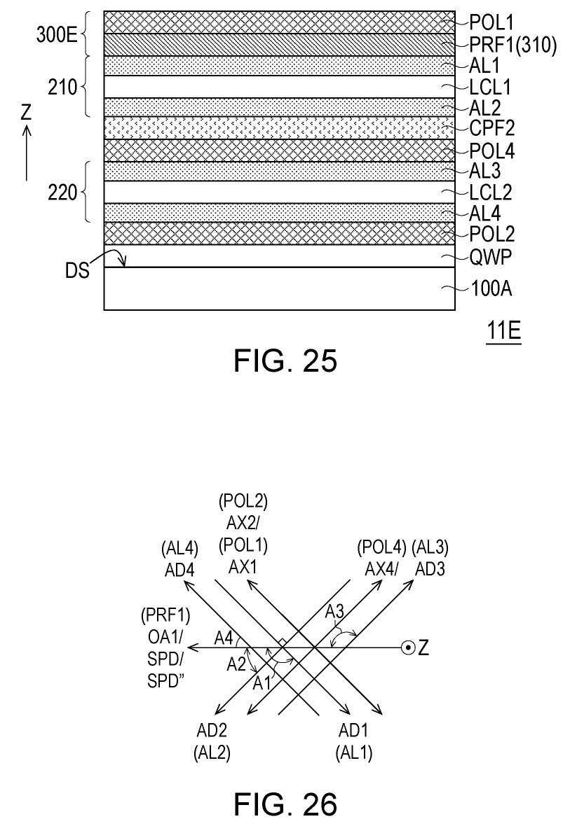

FIG. 25 is a schematic cross-sectional view of a display apparatus according to a twelfth embodiment of the disclosure. FIG. 26 is a schematic diagram illustrating the configuration relationship between axial directions of absorption axes of polarizers, alignment directions of alignment layers and an axial direction of an optical axis of a phase retardation film of FIG. 25. Referring to FIG. 25 and FIG. 26, the main difference between a display apparatus 11E of the embodiment and the display apparatus 10E of FIG. 13 lies in that the type and location of the display panel are different.

Specifically, in the display apparatus 11E of the embodiment, the display panel 100A may be a self-luminous display panel. The polarization modulator 300E is disposed on one side of the first electrically controlled phase retarder 210 facing away from the display panel 100A. That is, the first electrically controlled phase retarder 210 is located between the display panel 100A and the polarization modulator 300E. It is particularly noted that, in the embodiment, the display apparatus 11E is further provided with a quarter-wave plate QWP between the polarizer POL2 and the display panel 100A. The quarter-wave plate QWP and the polarizer POL2 may constitute a circular polarizer.

Since the technical effect of the polarization modulator 300E of the embodiment on the display apparatus 11E is similar to the technical effect of the polarization modulator 300B of FIG. 7 on the display apparatus 10B, the detailed description can be referred to the relevant paragraphs of the aforementioned embodiments, which will not be described again herein.

To sum up, in a display apparatus of an embodiment of the disclosure, an electrically controlled phase retarder disposed between two polarizers whose absorption axes are perpendicular to each other allows the display apparatus to have an electrically switchable anti-peeping effect. By configuring a phase retardation film in the polarization modulator, the light emission of the display apparatus at large viewing angles on the non-anti-peeping side can be effectively suppressed. On the other hand, by controlling the sum of the in-plane phase retardation of the polarization modulator within the range of -50 nm to 50 nm may ensure that the brightness of the display apparatus at a normal viewing angle is not reduced due to the arrangement of the polarization modulator.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A display apparatus, comprising:
a display panel, a first electrically controlled phase retarder, a polarization modulator and a second polarizer, wherein the display panel has a display surface,
the first electrically controlled phase retarder overlaps the display panel,
the polarization modulator includes a first polarizer and a polarization modulation unit,
the first polarizer has a first absorption axis, the polarization modulation unit includes a first phase retardation film, the first phase retardation film has a first optical axis, an orthographic projection of the first optical axis on the display surface is not parallel and not perpendicular to an orthographic projection of the first absorption axis on the display surface, a sum of an in-plane phase retardation of the polarization modulation unit is greater than or equal to -50 nm and less than or equal to 50 nm,
the second polarizer is disposed on one side of the first electrically controlled phase retarder facing away from the polarization modulator and has a second absorption axis, and the second absorption axis is perpendicular to the first absorption axis.

2. The display apparatus according to claim 1, wherein the polarization modulation unit further includes a first compensation film, the first compensation film has a compensation optical axis, and the compensation optical axis is not parallel and not perpendicular to the first absorption axis.

3. The display apparatus according to claim 2, further comprising:
a second compensation film, wherein the second compensation film is disposed between the first electrically controlled phase retarder and the first polarizer or the second polarizer.

4. The display apparatus according to claim 1, wherein the orthographic projection of the first optical axis on the display surface is not parallel and not perpendicular to the orthographic projection of the first absorption axis on the display surface.

5. The display apparatus according to claim 1, wherein the polarization modulator further includes a third polarizer, the third polarizer has a third absorption axis, the third absorption axis is parallel to the first absorption axis, and the first phase retardation film is located between the first polarizer and the third polarizer.

6. The display apparatus according to claim 1, wherein the first electrically controlled phase retarder includes a first alignment layer, a second alignment layer and a first liquid crystal layer, the first alignment layer has a first alignment direction, the second alignment layer has a second alignment direction, the second alignment direction is perpendicular to the first alignment direction, the first liquid crystal layer is disposed between the first alignment layer and the second alignment layer, the first alignment layer is disposed between the first liquid crystal layer and the polarization modulator, the first alignment direction is parallel to the first absorption axis, and the second alignment direction is parallel to the second absorption axis.

7. The display apparatus according to claim 6, further comprising:
a second electrically controlled phase retarder and a third polarizer, wherein the second electrically controlled phase retarder overlaps the display panel, the third polarizer is disposed on one side of the second electrically controlled phase retarder facing away from the first electrically controlled phase retarder and has a third absorption axis, and the second polarizer is located between the first electrically controlled phase retarder and the second electrically controlled phase retarder.

8. The display apparatus according to claim 7, wherein the second electrically controlled phase retarder includes a third alignment layer, a fourth alignment layer and a second liquid crystal layer, the third alignment layer has a third alignment direction, the fourth alignment layer has a fourth alignment direction, the fourth alignment direction is perpendicular to the third alignment direction, the second liquid crystal layer is disposed between the third alignment layer and the fourth alignment layer, the third alignment layer is disposed between the first liquid crystal layer and the second liquid crystal layer, the third alignment direction is parallel to the second absorption axis, and the fourth alignment direction is parallel to the third absorption axis.

9. The display apparatus according to claim 1, wherein the polarization modulation unit further includes a second phase retardation film, the second phase retardation film has a second optical axis, and an orthographic projection of the second optical axis on the display surface is perpendicular to the orthographic projection of the first optical axis on the display surface.

10. The display apparatus according to claim 1, wherein the first phase retardation film is disposed between the display panel and the first polarizer.

11. The display apparatus according to claim 1, wherein the first phase retardation film is disposed between the first electrically controlled phase retarder and the first polarizer.

12. The display apparatus according to claim 1, wherein the first phase retardation film is an O-plate.

13. The display apparatus according to claim 1, further comprising:
a backlight module and a half-wave plate, wherein the backlight module is disposed on one side of the first electrically controlled phase retarder facing away from the display panel, the half-wave plate is disposed between the display panel and the polarization modulator, the display panel is a non-self-luminous display panel, and the polarization modulator is disposed between the display panel and the first electrically controlled phase retarder.

14. The display apparatus according to claim 1, wherein the display panel is a self-luminous display panel, and the polarization modulator is disposed between the display panel and the first electrically controlled phase retarder.

15. The display apparatus according to claim 1, wherein the display panel is a self-luminous display panel, and the first electrically controlled phase retarder is disposed between the display panel and the polarization modulator.

16. The display apparatus according to claim 1, further comprising:
a quarter-wave plate, disposed between the second polarizer and the display panel.

17. A polarization modulator, comprising:
a first polarizer and a polarization modulation unit, wherein the first polarizer has a first absorption axis, the polarization modulation unit includes a first phase retardation film, the first phase retardation film has a first optical axis, an orthographic projection of the first optical axis on the first polarizer is not parallel and not perpendicular to the first absorption axis, and a sum of an in-plane phase retardation of the polarization modulation unit is greater than or equal to -50 nm and less than or equal to 50 nm.

18. The polarization modulator according to claim 17, wherein the polarization modulation unit further includes a first compensation film, the first compensation film has a compensation optical axis, and the compensation optical axis is not parallel and not perpendicular to the first absorption axis.

19. The polarization modulator according to claim 17, wherein the polarization modulation unit further includes a second phase retardation film, the second phase retardation film has a second optical axis, and the orthographic projection of the first optical axis on the first polarizer is perpendicular to an orthographic projection of the second optical axis on the first polarizer.
